(19) United States
(12) Patent Application Publication
(10) Pub. No.: US 2010/0197461 A1
(43) Pub. Date: Aug. 5, 2010

(54) ENVIRONMENTALLY FRIENDLY FITNESS CENTER

(76) Inventor: Derek J. Czarnecki, Beverly Hills, CA (US)

Correspondence Address: DAVIS WRIGHT TREMAINE LLP/Los Angeles, 865 FIGUEROA STREET, SUITE 2400, LOS ANGELES, CA, 90017-2566, US

(21) Appl. No.: 12/701,002

(22) Filed: Feb. 5, 2010

Related U.S. Application Data
(60) Provisional application No. 61/150,217, filed on Feb. 5, 2009.

(51) Int. Cl. A63B 71/00; G06Q 90/00; G06F 15/16

(52) U.S. Cl. 482/2; 705/500; 709/217

(57) ABSTRACT

The invention relates to an environmentally and ecologically efficient gymnasium facility, equipment and systems that may be included in it, methods of operating it, and methods of doing business with it.

### CROSS-REFERENCE TO RELATED APPLICATIONS

This application claims the benefit of U.S. Provisional Application No. 61/150,217, filed Feb. 5, 2009, the contents of which are hereby incorporated by reference in their entirety.

### FIELD OF THE INVENTION

The invention relates to an environmentally and ecologically efficient gymnasium facility, equipment and systems that may be included in it, methods of operating it, and methods of doing business with it.

### BACKGROUND OF THE INVENTION

All publications herein are incorporated by reference to the same extent as if each individual publication or patent application was specifically and individually indicated to be incorporated by reference. The following description includes information that may be useful in understanding the present subject matter. It is not an admission that any of the information provided herein is prior art or relevant to the presently claimed subject matter, or that any publication specifically or implicitly referenced is prior art.

In these environmentally conscious times, people are demanding that cars, factories and businesses be friendly to the environment. Increased emphasis on conserving energy, reclaiming unused sources of energy, and identifying new and environmentally friendly forms of energy are top priorities for nearly all businesses and society in general. This demand has in turn spawned industries dedicated to furthering the development of eco-friendly methods such as green cleaning, integrated pest management, and environmental waste management, all in an effort to establish more environmentally and ecologically responsible methods of doing business, utilizing energy and going about our everyday lives and activities.

The search for renewable clean power has created numerous environmentally friendly, relatively non-polluting approaches to generating electricity, such as geothermal power, hydro power, wind power, solar power, tidal power and wave power. However, the integration of these technologies into everyday life—even at the most basic levels in our homes, workplaces and schools—have been limited. In addition, mechanisms for recapturing energy and utilizing recaptured energy have yet to be developed for everyday use in most settings.

The development of energy conservation methods and environmentally friendly methods for powering businesses and doing everyday activities is an important and desired step forward in addressing growing environmental and ecologic concerns. As exemplified by the explosion in the popularity of electric cars for reduction of emissions and greenhouse gases, to the conscious conservation efforts of individuals in recycling and replacing household toxic products with eco-friendly alternatives, there exists a demand for environmentally and ecologically conscious methods of conducting a business.

The concept of exercising in a gymnasium stems back to ancient Greece, where a gymnasium was a locality for both physical and intellectual education of young men. The latter meaning of intellectual education persisted in German and other languages to denote a certain type of school providing secondary education, the gymnasium, whereas in English the meaning of physical education was pertained in the word gym. Today, being a member of a gymnasium is typical for many people, and oftentimes students and others at colleges and high schools, middle and elementary schools use gymnasia as well. These facilities are utilized for physical education, intramural sports and interscholastic athletics. In recent years, the advent of private fitness centers with sophisticated fitness and exercise equipment, personal trainers, group classes and the like has permeated nearly every community, large and small.

As the goals while engaging in physical activity are various, the end result dictates the expenditure of energy to achieve fitness. As energy has become more and more of a precious resource, the global community has directed its attention to recapturing and conserving energy. It is only appropriate that humans aspire to define efficient methods for utilizing energy. As a gymnasium is, by its design, intended to be an environment for humans to expend energy, a gymnasium is the ideal place for harnessing energy from humans.

In the setting of fitness and exercise facilities, such as commercial gymnasia, it would be advantageous to provide for systems and methods that enable one to harness or reclaim energy that is expended by a user in operating an item of fitness equipment along with a host of additional green and clean devices, systems and methods.

### BRIEF DESCRIPTION OF THE DRAWINGS

Exemplary embodiments are illustrated in referenced figures, where like numerals represent similar items. It is intended that the embodiments and figures disclosed herein are to be considered illustrative rather than restrictive.

FIG. 1 depicts a plan for a gymnasium, in which exercise devices in electrical communication with energy recapture systems, storage devices and electrical apparatuses are included, in accordance with an embodiment of the present invention.

FIG. 2 depicts a user with a stationary bicycle configured to capture energy expended by the user, the bicycle in electrical communication with a series of different electrically-powered apparatuses that are at least partially powered by the user through expenditure of energy in operating the bicycle, in accordance with an embodiment of the present invention.

FIG. 3 depicts a plan for a gymnasium, in which a water purification system is included and is in fluid communication with access points for drinking water and showers located within the gymnasium, as well as an external water supply, in accordance with an embodiment of the present invention. The plan for the gymnasium also separately depicts the use of recycling bins, in accordance with an embodiment of the present invention.

FIG. 4 depicts a plan for a gymnasium, in which compact fluorescent lights are used, in accordance with an embodiment of the present invention.

FIG. 5 depicts a plan for a gymnasium, in which recyclable cleaning products, energy efficient appliances and recycled rubber mats are used, in accordance with an embodiment of the present invention.

FIG. 6 depicts a plan for a gymnasium that is at least partially constructed from recycled construction materials and organic paints, in accordance with an embodiment of the present invention.

FIG. 7 depicts a plan for a gymnasium, in which the potentially deleterious effects of electromagnetic forces (EMF) produced by the electrical equipment used therein are at least partially mitigated through the use of at least one EMF negator, in accordance with an embodiment of the present invention.

FIG. 8 depicts a flow chart illustrating a donation made by a gymnasium to clean energy companies, in accordance with an embodiment of the present invention.

FIG. 9 depicts a flow chart illustrating a secure system for members of a gymnasium to direct donations by the gymnasium to particular philanthropic accomplishments, in accordance with an embodiment of the present invention.

FIG. 10 depicts a flow chart illustrating a system in which members of a gymnasium who perform environmentally conscious acts are rewarded with discounts on goods and services, in accordance with an embodiment of the present invention.

FIG. 11 depicts two users, each with a stationary bicycle configured to capture energy expended by the users, the bicycles in electronic communication with at least one communications network, in accordance with an embodiment of the present invention.

FIG. 12 depicts a user with a stationary bicycle configured to capture energy expended by the user, the bicycle including an integrated game console, in accordance with an embodiment of the present invention.

FIG. 13 depicts a group of users using a group of stationary bicycles in a gymnasium setting, the bicycles each configured to capture energy expended by the users, in accordance with an embodiment of the present invention. In various embodiments, the users depicted in such fashion may be engaged in a competition with one another and/or with users of similar equipment in remote locations through the depicted network connection. Additionally depicted are a range of environmentally conscious elements that may be included in the gymnasium, and, where desirable and relevant, such elements may be powered at least in part by energy harnessed from the users of the bicycles.

### DETAILED DESCRIPTION OF THE INVENTION

All publications herein are incorporated by reference to the same extent as if each individual publication or patent application was specifically and individually indicated to be incorporated by reference. The following description includes information that may be useful in understanding the present invention. It is not an admission that any of the information provided herein is prior art or relevant to the presently claimed invention, or that any publication specifically or implicitly referenced is prior art.

One skilled in the art will recognize many methods and materials similar or equivalent to those described herein, which could be used in the practice of the present invention. Indeed, the present invention is in no way limited to the methods and materials described.

Unless defined otherwise, technical and scientific terms used herein have the same meaning as commonly understood by one of ordinary skill in the art to which this invention belongs.

The invention relates to an environmentally and ecologically efficient gymnasium facility, equipment and systems that may be included in it, methods of operating it, and methods of doing business with it. The goal is to operate a self-sufficient, carbon-neutral exercise environment by fitting exercise equipment within the gymnasium with an energy recapturing system capable of recapturing energy produced by members. In turn, the invention enables individuals the opportunity to create their own energy and belong to a network of environmentally conscious individuals. The invention further teaches incorporation of various systems for promoting an energy-efficient, environmentally-responsible gymnasium, including, but in no way limited to, installing a catalytic ozone converter to purify the air in the gymnasium, thus allowing members to breathe pure air free of such contaminants as spores, mold, fungi, bacteria, viruses, ozone, smog and metals while they work out. The method also teaches utilization of solar panels to convert solar energy into electrical energy. Numerous other advantages and features of the “green gym” of the present invention will be understood with reference to the following description and associated drawings.

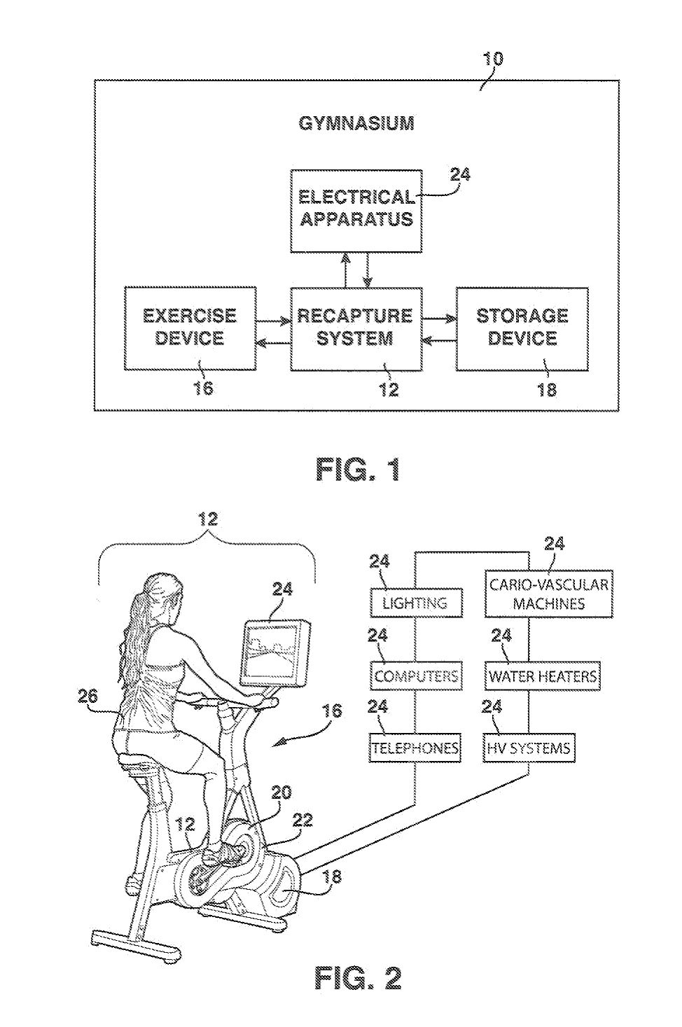

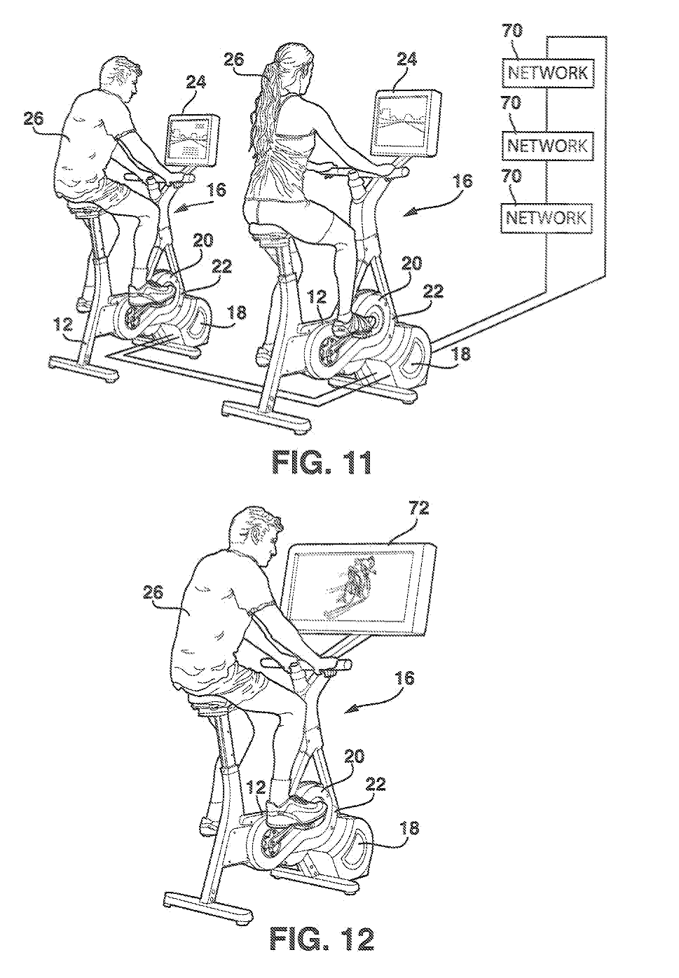

Among the elements that may be included in the gymnasium is fitness equipment that, when operated by a user, generates an amount of electricity for storage and/or immediate use, either by the fitness equipment or by other devices that utilize electricity. Examples of such equipment are described in U.S. patent application Ser. No. 12/700,962, titled “Fitness Equipment with Power Generation,” filed Feb. 5, 2010, the contents of which are hereby incorporated by reference in their entirety as though fully set forth. References throughout to exercise bicycles, fitness equipment and the various components, systems and methods implemented with them, should be construed to broadly capture those items described in the aforementioned co-pending application. This is illustrated in FIG. 1, and the use of such equipment 12 is illustrated in FIG. 2, in which an exercise bicycle 16 is operated by a user 26 to actuate a generator 20, which through a rectifier 22 supplies an electric current that can be stored in a battery 16 and/or transmitted to power various electrical apparatuses 24. This is further illustrated in FIGS. 11 and 12, which depict two users 26 using bicycles 16 in communication with at least one communications network 70, and a user 26 with a stationary bicycle 16 including an integrated game console 72, respectively.

The energy captured and/or stored through use of the fitness equipment can be used to supply power to a host of devices within a gymnasium; for example, but in no way limited to, lighting, computers, telephones, cardiovascular machines, and water heaters. Those of skill in the art will recognize a host of additional items that can be powered by energy obtained through the aforementioned fitness equipment.

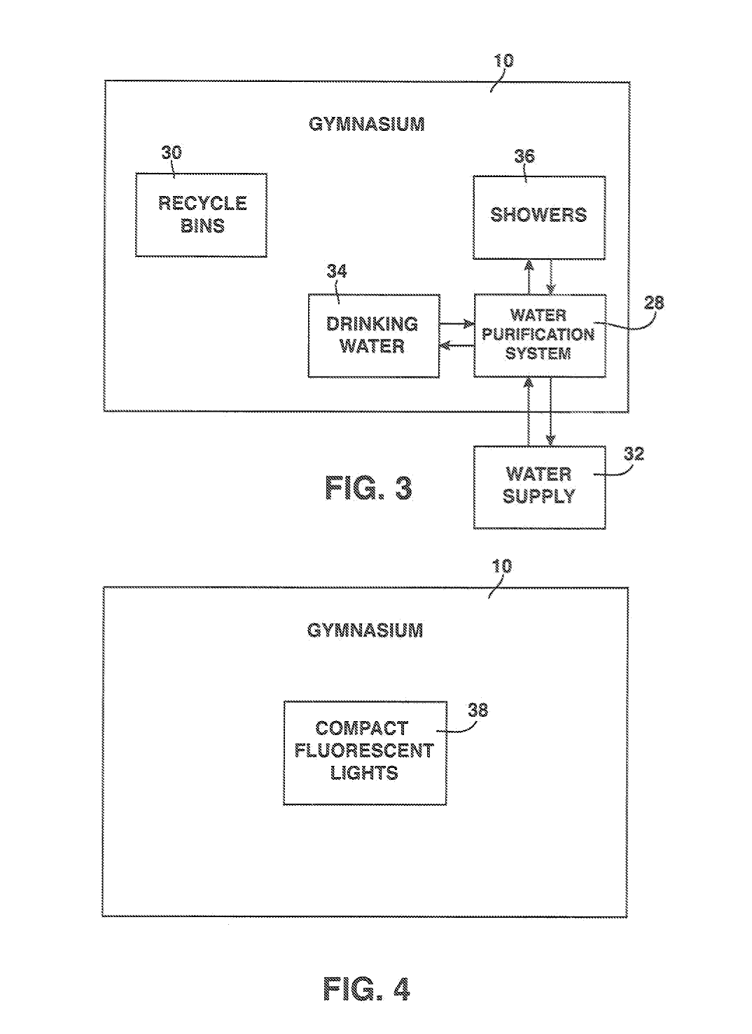

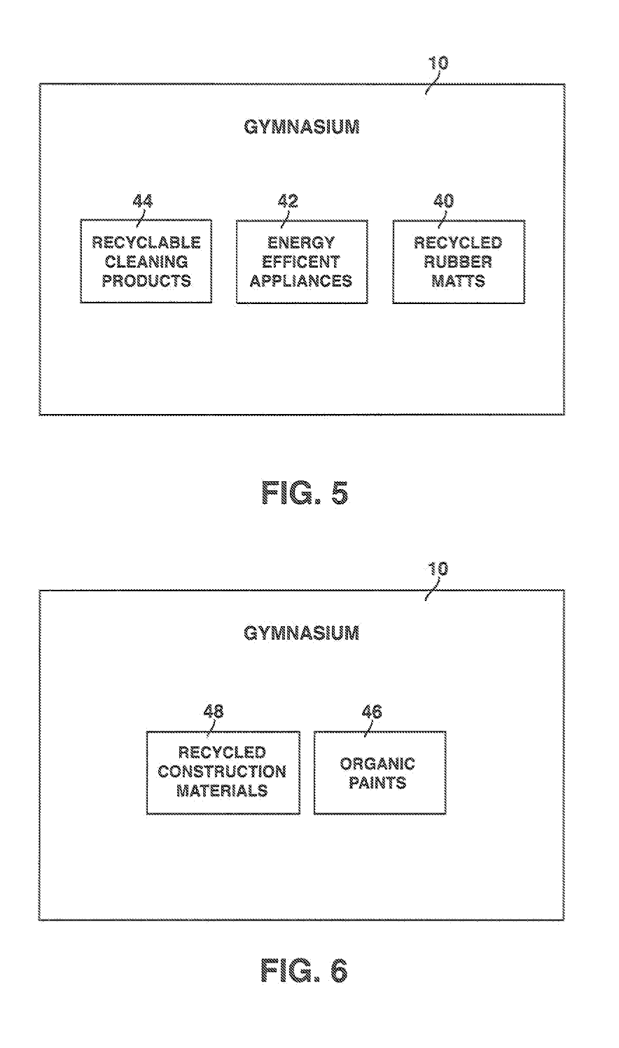

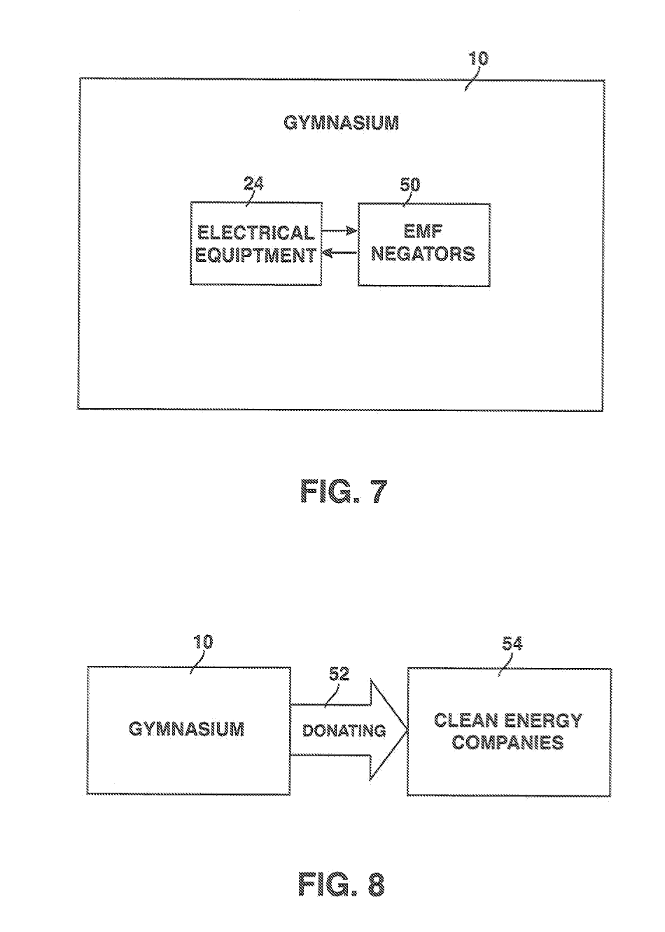

In accordance with various embodiments of the present invention, a gymnasium 10 may include a wide array of features generally recognized by those of skill in this field as having qualities that are “eco-friendly,” “environmentally conscious,” “green” or like designations. In addition to incorporating the use of one or more forms of fitness equipment 16 that can be used to capture, store and/or utilize energy expended by users 26 of the equipment 16, the gymnasium 10 may include one or more of the following features: a water purification system 28 in fluid communication with access points for drinking water 34 and/or showers 36 located within the gymnasium 10, as well as an external water supply 32 (FIG. 3); recycle bins 30 where recyclable materials can be discarded (FIG. 3); compact fluorescent lights 38 or other lighting products and systems that have environmentally beneficial qualities (FIG. 4); use of recyclable cleaning products 44 to perform cleaning activities, energy efficient appliances 42 for various tasks and recycled rubber mats 40 as floor coverings and exercise mats (FIG. 5); construction of at least a portion of the gymnasium 10 from recycled construction materials 48 and organic paints 46 and other eco-friendly building materials that will be readily recognized by those if skill in the art (FIG. 6); and/or use of EMF negators 50 to address the potentially deleterious effects of EMF produced by electrical equipment 24 in the gymnasium 10 (FIG. 7).

The water purification system may offer gym members clean filtered water, thus eliminating the need to purchase water in plastic bottles, therefore reducing consumption and waste. If members do bring in their own water bottles or other sports beverages, the gymnasium may provide recycle bins for disposal. Furthermore, the water purification system may not only purify drinking water but all water coming into the gymnasium, thus also supplying purified water to, for example, the showers. As chemical and toxin free water for showering is extremely beneficial for the health of the body, members may benefit from this feature.

The use of compressed fluorescent light bulbs to reduce energy consumption and the reduction of energy use during off-peak hours by reducing lighting are additional features that may be incorporated into the gymnasium of the present invention. In yet another embodiment, gymnasium flooring will be composed of recycled rubber mats. Furthermore, the gymnasium may utilize energy efficient appliances, as well as environmentally friendly and recyclable cleaning products, shampoo, soap, bathroom tissue and other paper products.

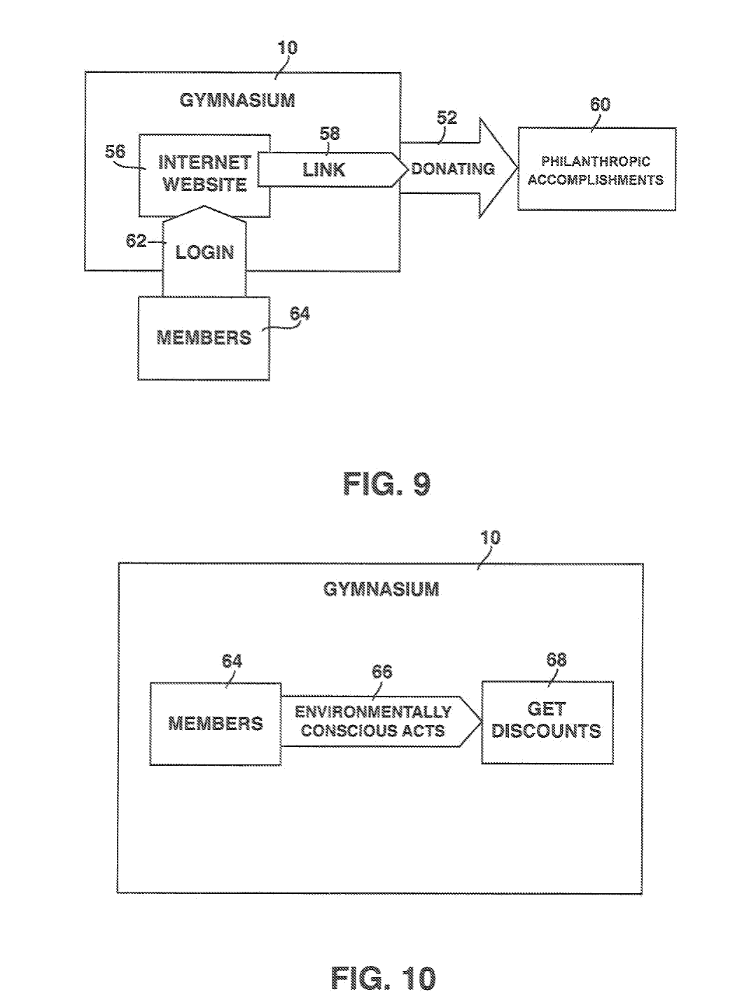

Additionally, in further embodiments of the present invention, a variety of business methods may be utilized to further incorporate the environmentally conscious nature of the gymnasium and its business. In one embodiment, donations 52 may be made by the gymnasium 10 to clean energy companies 54 (FIG. 8). In another embodiment, (FIG. 9) a secure system for members 64 of a gymnasium 10 to login 62 through the gymnasium's Internet website 56 to direct donations 52 through a link 58 by the gymnasium 10 to particular philanthropic accomplishments 60 may be incorporated, and such philanthropic accomplishments 60 may, in one embodiment, be related to promoting the wellbeing of the environment. In yet another embodiment, a system is included in which members 64 of a gymnasium 10 who perform environmentally conscious acts 66 are rewarded with discounts on goods and services 68. The environmentally conscious acts 66 can include any variety of items that would be recognized as having an environmental benefit, such as, but in no way limited to driving hybrid or vegetable oil powered cars, installing solar panels on one's house, riding ones bicycle to the gymnasium and being employed by environmentally conscious businesses, and the discounts 68 may relate to goods and services sold by or at the gymnasium 10 or by off-site third parties.

The gymnasium may offset some or all new equipment purchases and hardware by donating to clean energy companies and energy credit companies to keep its carbon footprint as small as possible. In further embodiments, incentives and methods may be offered to gym members to calculate and eliminate or reduce their carbon footprint.

Another feature of the inventive business method for operating the gymnasium is to present advertising of the energy recapturing system to the public to attract customers to the gymnasium. The gymnasium may employ any suitable method of advertisement to advertise its services, such as bulk mailings, newspaper and magazine advertisements, radio commercials, television commercials, flyers, e-mail blasts, internet pop-up advertisements, telemarketing, and/or door-to-door sales.

During this advertising phase, when a potential customer patronizes the gymnasium for the first time, the potential customer is introduced to the gymnasium's operating system, namely, the energy recapturing system. Furthermore, the potential customer will be introduced to additional environmentally friendly and conscious features integrated into the operating system of the gymnasium. The potential customer may walk in, or have a pre-scheduled appointment. The gymnasium business method further comprises greeting the prospective member, obtaining basic customer information from the prospective member, and entering the basic customer information into a customer database. The basic customer information may include a name, an address, and at least one telephone number for the prospective member. In the present method, a software program on a computer preferably stores the customer database.

In addition, the prospective member may be informed of services available in the gymnasium, including, elite private fitness trainers, spinning, yoga and Pilates instructors, as well as various cardiovascular machines (treadmills, lifecycles, elliptical machines) and free weight areas.

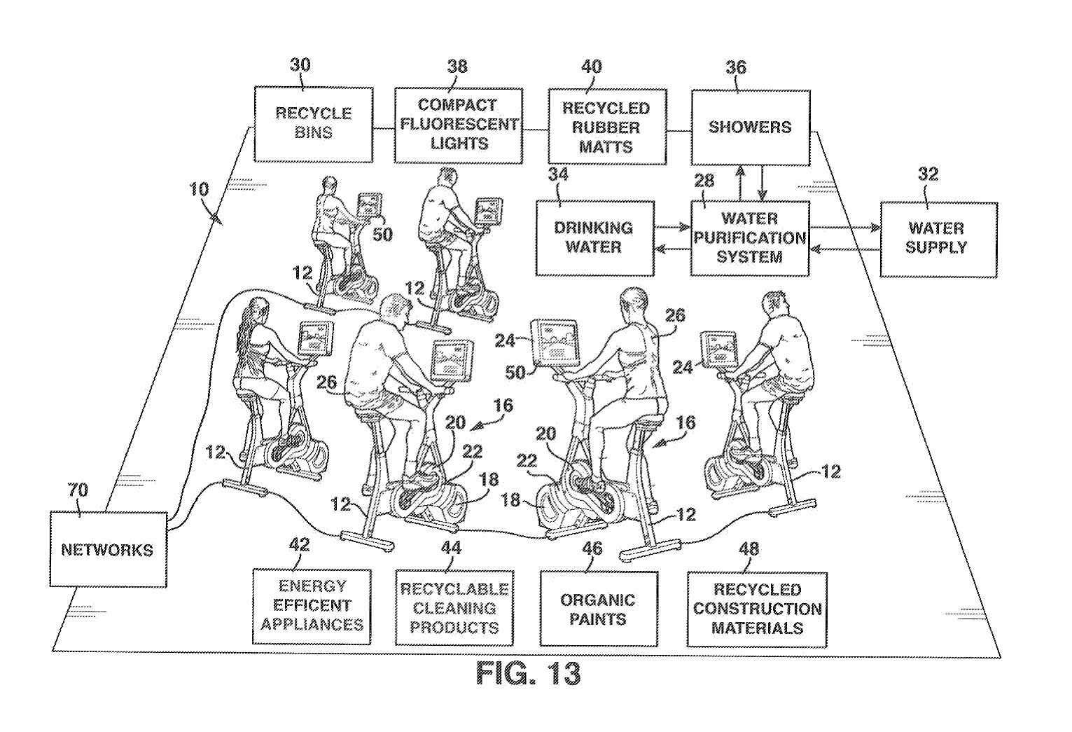

In an embodiment of the invention, one, more or all of the features described above can be incorporated into a gymnasium 10 and its business operations, as illustrated in FIG. 13.

Various embodiments of the invention are described above in the Detailed Description. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s).

The foregoing description of various embodiments of the invention known to the applicant at this time of filing the application has been presented and is intended for the purposes of illustration and description. The present description is not intended to be exhaustive nor limit the invention to the precise form disclosed and many modifications and variations are possible in the light of the above teachings. The embodiments described serve to explain the principles of the invention and its practical application and to enable others skilled in the art to utilize the invention in various embodiments and with various modifications as are suited to the particular use contemplated. Therefore, it is intended that the invention not be limited to the particular embodiments disclosed for carrying out the invention.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”) the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

What is claimed is:

1. A gymnasium, comprising:
at least two articles of fitness equipment, each comprising:
an element configured to be actuated through an expenditure of energy by a user, and
a generator to convert to an electric current at least a portion of the energy expended by the user in actuating the article of fitness equipment,
wherein the electric current supplies electricity to at least one apparatus in the gymnasium, other than the at least two articles of fitness equipment.

2. The gymnasium of claim 1, wherein each article of fitness equipment further comprises a battery to store energy converted by the generator.

3. The gymnasium of claim 1, wherein each article of fitness equipment further comprises a rectifier in electric communication between the generator and the battery.

4. The gymnasium of claim 1, wherein each article of fitness equipment is independently selected from the group consisting of a stationary bicycle, a stepper, a treadmill, an elliptical machine and a weight machine.

5. The gymnasium of claim 1, wherein each article of fitness equipment is a stationary bicycle and the element is the pedals of the stationary bicycle.

6. The gymnasium of claim 1, wherein each article of fitness equipment is configured to transmit and/or receive data through at least one communications network.

7. The gymnasium of claim 1, wherein each article of fitness equipment is configured to communicate with a game console and/or a video camera.

8. The gymnasium of claim 1, wherein each article of fitness equipment is configured to provide energy converted by the generator to an external battery.

9. The gymnasium of claim 1, further comprising at least one feature selected from the group consisting of: (a) a water purification system in fluid communication with access points for drinking water and/or showers located within the gymnasium, and, optionally, in further communication with an external water supply, (b) recycling bins for disposal of recyclable materials; (c) compact fluorescent lighting; (d) energy efficient appliances; (e) recycled rubber mats; (f) being at least partially constructed from recycled construction materials and/or organic paints; (g) at least one EMF negator; and (h) combinations thereof.

10. A method of doing business, comprising:
providing a gymnasium, comprising:
at least two articles of fitness equipment, each comprising:
an element configured to be actuated through an expenditure of energy by a user, and
a generator to convert to an electric current at least a portion of the energy expended by the user in actuating the article of fitness equipment,
wherein the electric current supplies electricity to at least one apparatus in the gymnasium, other than the at least two articles of fitness equipment;
providing access to the gymnasium to customers.

11. The method of claim 10, wherein each article of fitness equipment further comprises a battery to store energy converted by the generator.

12. The method of claim 10, wherein each article of fitness equipment further comprises a rectifier in electric communication between the generator and the battery.

13. The method of claim 10, wherein each article of fitness equipment is independently selected from the group consisting of a stationary bicycle, a stepper, a treadmill, an elliptical machine and a weight machine.

14. The method of claim 10, wherein each article of fitness equipment is a stationary bicycle and the element is the pedals of the stationary bicycle.

15. The method of claim 10, wherein each article of fitness equipment is configured to transmit and/or receive data through at least one communications network.

16. The method of claim 10, wherein each article of fitness equipment is configured to communicate with a game console and/or a video camera.

17. The method of claim 10, wherein each article of fitness equipment is configured to provide energy converted by the generator to an external battery.

18. The method of claim 10, wherein the gymnasium further comprises at least one feature selected from the group consisting of: (a) a water purification system in fluid communication with access points for drinking water and/or showers located within the gymnasium, and, optionally, in further communication with an external water supply, (b) recycling bins for disposal of recyclable materials; (c) compact fluorescent lighting; (d) energy efficient appliances; (e) recycled rubber mats; (f) being at least partially constructed from recycled construction materials and/or organic paints; (g) at least one EMF negator; and (h) combinations thereof.

19. The method of claim 10, further comprising cleaning the gymnasium and/or its contents with recyclable cleaning products.

20. The method of claim 10, further comprising an additional step selected from the group consisting of: (a) making a donation to a clean energy company; (b) providing a secure system for customers to login and direct a donation to achieve a philanthropic accomplishment; (c) rewarding customers who perform environmentally conscious acts with a discount on goods or services; and (d) combinations thereof.

21. The method of claim 10, further comprising providing a competitive class for customers to utilize the articles of fitness equipment to compete against one another in generating electricity for the gymnasium.
